(19) United States
(12) Patent Application Publication
(10) Pub. No.: US 2016/0058046 A1
(43) Pub. Date: Mar. 3, 2016

(54) METHOD FOR PRODUCING GRANULES CONTAINING AN ACTIVE INGREDIENT, HAVING AN OPTIMISED BEST-BEFORE DATE AND ACTIVE INGREDIENT LOAD

(71) Applicant: EXPRESSIONS AROMATIQUES, Mouans Sartoux (FR)

(72) Inventors: Vincent Carpentier, Saint Cezaire sur Siagne (FR); Benedicte Ravel, Grasse (FR)

(21) Appl. No.: 14/888,299

(22) PCT Filed: Jun. 20, 2014
(86) PCT No.: PCT/FR2014/051551

§ 371 Date: Oct. 30, 2015

(30) Foreign Application Priority Data
Jun. 25, 2013 (FR) 13 56086

(51) Int. Cl. A23L 1/22; A23L 1/00

(52) U.S. Cl. CPC A23L 1/22008; A23L 1/0023; A23L 1/0076; A23V 2002/00

(57) ABSTRACT

A method for producing granules that contain at least one active ingredient and are stable at ambient temperature, includes successively: (1) preparing a matrix free of an active ingredient by mixing, without the addition of water, an encapsulation vehicle for the active ingredient and a non-aqueous plasticiser compatible with the vehicle and the active ingredient, the encapsulation vehicle and the plasticiser being present in amounts that give the matrix a glass transition temperature higher than the ambient temperature; (2) heating the matrix in an extruder to an extrusion temperature to produce an amorphous melt matrix; (3) injecting the active ingredient into the melt matrix; (4) extruding the melt mass including the active ingredient through a die and cutting granules at an exit point of the die.

### FIELD OF THE INVENTION

The invention relates to a production method for producing granules that contain at least one active ingredient for example an aromatic active ingredient, and are soluble and stable at ambient temperature.

### BACKGROUND

Granules of this type may be used in a variety of applications: agri-food products such as flavoured teas, instant beverages; cosmetics or pharmaceuticals, in each of which it is important that they retain their properties for as long as possible.

To this end, it is preferable that these granules have a glass transition (or glass transition) temperature, a temperature of transitioning from a glassy state to a rubbery amorphous state, that is much higher than the ambient temperature so that this transition does not take place in an incessant manner and the appearance, texture and structure of the granules do not get modified.

In the granule producing method of this kind, known in particular from the document EP 1 124 442, these granules are prepared by means of extrusion from a mixture of a carbohydrate matrix with an aromatic active ingredient. This matrix is heated to an extrusion temperature and then melt passed through an extrusion die to finally be cut at the die outlet. In order to provide the granules with a vitreous transition temperature that is higher than the ambient temperature, an amount of water that is less than that heretofore used, is added to the mixture in a manner so as to limit the effect of the water on the glass transition temperature of the granules, with the water tending to reduce the glass transition temperature.

In addition, this method allows for the direct cutting of the granules at the extruder outlet, that is to say without an intermediate drying or cooling step, because the matrix heated at the extrusion temperature is plastic and can for this reason be shaped and formed directly at the extruder outlet.

This is achieved through:
the use of an extrusion temperature such that the carbohydrate matrix, having high viscosity, and the aromatic active ingredient, having low viscosity, do not separate during the extrusion although these two compounds have viscosities that differ from each other by several orders of magnitude;
the use of an extrusion pressure such that the extrusion, which is necessarily carried out at a temperature that is greater than the glass transition temperature, can take place while the mass in the molten state is however plastic, and this occurs without addition of a non-aqueous plasticiser, which, in this method is not desired.

### SUMMARY OF THE INVENTION

The invention provides a production method for producing granules that contain at least one active ingredient, alternative to that described here above, and whose main objective is to provide the granules obtained, with a significant aromatic - , cosmetic-, pharmaceutical load, and an optimal shelf life or best before date (BBD) period that is greater than or equal to 24 months and whose dosing in solution is optimised.

To this end, the invention concerns a production method for producing granules that contain at least one active ingredient and are stable at ambient temperature, comprising the successive steps of:

(1) preparing a matrix free of active ingredient by mixing, without the addition of water, an encapsulation vehicle for the active ingredient and a non-aqueous plasticiser compatible with the said vehicle and with the chosen active ingredient, the encapsulation vehicle and the plasticiser being present in amounts that give the matrix a glass transition temperature that is higher than the ambient temperature;

(2) transformation of the matrix heated in an extruder to an extrusion temperature in order to obtain an amorphous melt matrix;

(3) injection of the active ingredient into the melt matrix, in order to provide the melt mass with a given determined active agent;

(4) extruding the melt mass provided with the active ingredient through a die and cutting the same into the form of granules at a point of exit of this mass from the die.

The invention has one or more of the following characteristic features:
the plasticiser belongs to the family of polyols and is in the form of a non-aqueous liquid;
the plasticiser is monopropylene glycol or one of the derivatives thereof, glycerol or one of the derivatives thereof, or a mixture of these latter;
when the aromatic active ingredient is rich in terpenes, the plasticiser will be selected from glycerol diacetate, and/or glycerol triacetate, alone or in a mixture with monopropylene glycol or one of the derivatives thereof, glycerol or one of the derivatives thereof or a mixture of these latter;
the plasticiser is present in an amount that is less than a predetermined value at which the glass transition temperature of the matrix becomes greater than 40° C.;
the plasticiser is present in an amount that is less than 6% by weight relative to the total weight of the constituents of the granules;
the plasticiser is present in an amount that is greater than 1% by weight relative to the total weight of the constituents of the granules;
the encapsulation vehicle comprises a monosaccharide and/or a short chain polysaccharide alone or in a mixture, coupled with maltodextrins;
the active ingredient is combined with an emulsifier facilitating the dispersion of the active ingredient in the melt mass, and the dispersion of the active ingredient in the form of a fine emulsion in the aqueous solution in which the granules are incorporated;
the emulsifier has an HLB (Hydrophile-Lipophile Balance) value comprised between 8 and 18;
the emulsifier comprises polysorbates, sucroesters, mono-glycerides and di-glycerides of fatty acids, emulsifiers rich in saponins and lecithins alone or in a mixture;
the method comprises a step of maintaining the temperature of the melt mass provided with an active agent at the extruder outlet, between 45° C. and 55° C.

The invention also relates to granules provided with an active ingredient, comprising:
maltodextrin and monosaccharides or short chain polysaccharides in a ratio of between 80/20 and 20/80;
between 1% and 6% of MPG;
between 0.1% and 10% of an active ingredient.

### DETAILED DESCRIPTION

The invention will be defined in greater detail in the description that follows, which contains two instances of production of aromatised granules, given by way of illustrative and not limiting examples.

The method according to the invention has been developed with the objective of producing aromatised granules having a high aromatic load, an optimal best before date period that is greater than or equal to 24 months, which dissolve without any problematic turbidity in aqueous media and have the following characteristic features:
Aromatic load of between 0.1% and 10%, preferably between 2% to 10%;
Optimal dosing of aromatised granules in the solution formed after the addition of water: 0.2 g·L⁻¹ to 1 g·L⁻¹;
Residual moisture less than 5%;
Glass transition temperature that is greater than 40° C.;
Optimised best-before date period (shelf life) of greater than or equal to 24 months;
Clear water-dispersible flavouring in the solution formed.

The principle for the extrusion has been selected because it provides for excellent encapsulation of the aromatic ingredients that thus find themselves protected from the external environment and the causes of deterioration of flavour, odour or taste.

It consists of inserting a powder mixture containing an encapsulation vehicle, a plasticiser and an aromatic ingredient, of the desired composition, within an extrusion apparatus, where this mixture is heated to an extrusion temperature until a malleable melt mass is obtained, this melt being introduced at the inlet of a die whose diameter is close to that of the granules to be obtained, while still continuing to be malleable, and cut into granules at the die outlet, by a knife that cuts the wires formed at the die exit.

This method is operationally implemented within an extrusion apparatus, such as a twin screw extruder such as that marketed under the trade name of Clextral BC21.

This extruder is equipped in a known manner with a doser for the encapsulation vehicle wherein the powder mixture is introduced, with a co-rotating twin screw which will convey this mixture to the die, through various different modules equipped in particular with thermoregulatory mechanisms, the die itself being positioned downstream from the twin-screw extruder, possibly with a thermoregulated air blowing system at the die outlet, and a cutting device that is downstream from the outlet of the die, or downstream from the blowing system if the extruder is provided therewith.

In order to produce granules that are in conformity with the specifications outlined here above, the invention relates to a method that is operationally implemented in a co-rotating twin-screw extruder and comprises the successive steps of:

(1) preparing a matrix free of active ingredient by mixing, without the addition of water, an encapsulation vehicle for the active ingredient and a non-aqueous plasticiser compatible with the said vehicle and with the chosen active ingredient, the encapsulation vehicle and the plasticiser being present in amounts that give the matrix a glass transition temperature that is higher than the ambient temperature;

(2) transformation of the matrix heated in an extruder to an extrusion temperature in order to obtain an amorphous melt matrix;

(3) injection of the active ingredient combined with an emulsifier that is compatible with this active ingredient and with the plasticiser, within the melt matrix, in order to provide the melt mass with a given determined active ingredient;

(4) extruding the melt mass provided with the active ingredient through a die and cutting the same into the form of granules at a point of exit of this mass from the die.

The extruder suitable for the operational implementation of this method should be provided with an inlet point for entry of the active ingredient at the screw end and upstream of the die.

Thus, an extruder of this type will include, successively: a zone of incorporation of powders constituting the encapsulation vehicle, a zone of incorporation of the plasticiser ; along the twin-screw a zone of transformation of the matrix formed by the encapsulation vehicle mixed with the plasticiser into a matrix in the viscous state, a zone of incorporation of the flavouring into the matrix in the viscous state, a final mixing zone for mixing the flavouring into the matrix in the viscous state; the extrusion die and the cutting tool for cutting the granules at the outlet of this die.

The successive steps of the method according to the invention have been developed in order to avoid subjecting the active ingredient to thermal treatments that are likely to deteriorate the properties thereof.

The method according to the invention thus provides for not injecting it until at the very end of the process (step 3), that is to say, when the powder mixture has been sufficiently transformed so as to be in the form of a molten or melt mass and not requiring any addition of water in the initial mixture, so as to avoid any subsequent drying operation and the appearance of vapour pockets. This injection is to be effected at a point along the twin-screw that is the closest to the extrusion die in order to ensure a homogeneous dispersion of the aromatic ingredient within the matrix in the molten state at the end of the last mixing zone, thereby minimising the time of exposure of this active ingredient to the extrusion temperature. The residence time of the heat-sensitive aromatic ingredient within the extruder is thus optimised. By way of example, the injection of the active ingredient will be performed just before the last mixing zone of the twin screw, and then this melt mass will be introduced into the die.

Encapsulation Vehicle

The encapsulation vehicle which is combined with the plasticiser to form the non-aromatised matrix comprises carbohydrates: a mixture of short-chain polysaccharides such as sucrose, and maltodextrins for example having a DE (dextrose equivalent) value of 9 or 12 commonly used in the field of extruded flavouring materials. As a precaution particular care will however be taken in terms of the selection of the maltodextrin and its DE value so as to ensure that the resulting granules obtained have a glucose content of less than 0.5%, the value below which it could be observed that there is a total absence of the problem of the matrix getting stuck on to the twin-screw of the extruder, or on the outlet knife.

While short chain polysaccharides, such as mono- or disaccharide, have been particularly preferred, it is because they allow for better retention of the aromatic ingredient.

As for maltodextrins, their being selected has been due to the fact that they increase the glass transition temperature to a level greater than 40° C. or close to this value, so as to ensure the stability of the granules at ambient temperature.

The ratio of Maltodextrin/mono or polysaccharides in the matrix is comprised between 80/20 and 20/80, but remains limited by the requirement to ensure the granules obtained are provided with a glucose content that absolutely is less than 0.5% by way of extreme precaution in order to avoid any sticking problem.

The preferred ratio is of the order of 55/45.

The matrix should, quite obviously, be compatible with the selected plasticiser. A particle size of less than 1 mm will be preferred: the aggregates of carbohydrates should be small enough so as to be brought to melt rapidly in the presence of MPG (monopropylene glycol) or some other solvent of the same type. If such is not the case, a few pieces could block the holes of the die (the latter having a diameter of between 0.5 mm and 2 mm) and prevent the continuous production process from unfolding.

Plasticiser

The plasticiser provides for the transformation of this vehicle, in particular by heating, into a brilliant malleable mass free of aggregate.

In order to replace the water generally used as a plasticiser for this type of encapsulation vehicle and which involves steps that are constraining and quite likely to cause the evaporation of the aromatic ingredient (phases of drying and water vapour degassing) or cause premature aging of the aromatic ingredient, the method according to the invention provides for the use of a non-aqueous liquid plasticiser that acts as a solvent while having the function of rendering the rather hydrophobic aromatic ingredient, compatible with the encapsulation vehicle that is rather hydrophilic, and thus promoting the dispersion of the aromatic ingredient in the melt mass just prior to the passage through the die.

Its presence prevents the phenomenon of segregation between the encapsulation vehicle and the active ingredient, which generally occurs during heating, as these two compounds have viscosities that differ from each other by several orders of magnitude, since it lowers the viscosity of the encapsulation vehicle.

The addition of water having been prohibited, and the selected plasticiser having a high boiling point temperature, the formation of pockets of vapour water and flavouring substance is prevented, and the continuous production, without the interruption of degassing, is possible.

In order to further ensure that the granules obtained present an identical appearance regardless of the fluctuations in the ambient temperature, the nature and the concentration of the plasticiser are selected so as to give these granules a glass transition temperature that is significantly higher than the ambient temperature of 20-25° C., preferably higher than 40° C.

The plasticisers from the family of polyols, and more particularly monopropylene glycol, or derivatives thereof, glycerol or derivatives thereof, glycerol diacetate, glycerol triacetate, or a mixture thereof have been selected not only for their high boiling point temperature but also for their significant capacity for plasticising the encapsulation vehicle, which makes it possible to reduce the extrusion temperature applied during the course of the process and thereby reduces the thermal stresses to which the active ingredient is subjected during the introduction thereof in the melt mass brought to that temperature, and for their ability to bring about dispersion of an aromatic substance in the type of encapsulation vehicle selected. The polyols used are in the form of a non-aqueous liquid and in particular fulfill the role of the solvent as previously explained above.

It was possible to determine that monopropylene glycol (MPG) was the most efficient solubilising agent for the largest number of different types of aromatic ingredients, notably better than glycerol. Indeed, the main esters, alcohols, acids, aldehydes, ketones and heterocyclic compounds, which make up the majority of the aromatic ingredients, are soluble in MPG.

However its tendency to lower the glass transition temperature to below 40° C. or even below 20° C. when it is incorporated in extremely high proportions in a carbohydrate based encapsulation vehicle, obviously did not make for MPG selection becoming a requirement, with the risk being of having to use it in smaller proportions in order to ensure that a vitreous transition (or glass transition) temperature Tg greater than 40° C. is attained, with the disadvantage of not achieving a total plasticising of the matrix, which would then include aggregates of carbohydrates that could likely clog the die and lead to production stoppages, which would not be acceptable. And the solution of then increasing the extrusion temperature in order for plasticising these aggregates, is also not desirable as this is quite likely to damage the matrix, which is then found to be greyed out, and stained with spots of burned carbohydrates.

However, in a surprising fashion, it has been possible to determine an optimal level of MPG content, which ensures both a Tg below 40° C., and a total plasticisation of the matrix.

This MPG content is comprised between 1% and 6% by total weight of the constituent ingredients of the granules.

It turns out that this content level is substantially the same for the other plasticisers provided according to the invention.

Indeed, it has been possible to determine experimentally that MPG used based on a content level of 5% by weight of a matrix containing maltodextrins and saccharose based on a 55/45 content ratio, contributed to forming at the extruder outlet, granules having a glass transition temperature close to 50° C., which is highly appropriate value.

And when it is used at a concentration of 10% by weight in a matrix of the same type, the granules obtained exhibit a Tg of only 30° C., that is to say, a value that is too low for these granules to be sufficiently stable at ambient temperature.

The glycerol used based on a content level of 5% by weight in a matrix moreover also comprising the same ingredients, resulted in the formation of granules having a Tg of close to 45° C., which is a totally acceptable value whereas this temperature was no more than 19° C. when glycerol was used based on a content level of 10% by weight, an extremely low value.

The use of MPG or other plasticisers provided for by the invention, in the recommended content value below a threshold value (6% by weight of the constituent ingredients of the granules), has therefore made it possible to obtain a complete plasticising of the matrix and to provide the granules with a glass transition temperature that is greater than 40° C.

In addition the use of the MPG has also prevented the generation of vapour pockets, while making it possible to lower the extrusion temperature to 86° C. or to an even lower value, and to satisfy the requirements of the specifications cited above.

And it has been quite the same for the other types of plasticisers provided for according to the invention.

Indeed, the high boiling point temperature of MPG (188° C.) very considerably above the necessary and sufficient extrusion temperature of 86° C., prevents any formation of gas pockets which usually form with a plasticiser having a low boiling point such as water.

This observation has far greater truth with respect to glycerol, the boiling point of which goes up to 290° C., going up to 260° C. for glycerol diacetate and to 266° C. for glycerol triacetate.

These last individual plasticisers and the derivatives thereof, and particularly glycerol diacetate, glycerol triacetate or a mixture of the two, present the advantage of solubilising the aromatic ingredients of compositions that are rich in terpenes such as essential oils and are therefore preferentially used to encapsulate this type of active ingredient.

The extrusion temperature lowered to 86° C. or even below that, further increased the preservation of the properties of the aromatic active ingredient injected into the melt mass at this temperature.

These gains in terms of degrees Celsius as compared to existing extrusion processes like the one mentioned in the section of the description devoted to the discussion on the state of the art, are of importance in the light of the requirements established in the context of the invention for the aromatic load of the granules.

This effect has been observed for a plasticiser content equal to or greater than 1% by weight of the ingredients that are used to make up the granules.

For these reasons, the optimal plasticiser content has been fixed at between 1% and 6% by weight of the ingredients that are used to make up the granules.

The relatively low extrusion temperature leads to the obtaining at the extrusion die outlet, of a coil at also relatively low temperature and therefore rather liable to solidify rapidly. In order for this solidification to take place in optimal conditions, a maintenance module for maintaining these wires at the appropriate temperature (for example between 45° C. and 55° C.) will be provided between the outlet of the die and the knife, this temperature allowing for the formation of a solid external casing envelope for the wires, while the core of the wires remains molten, thereby also promoting a clean cut of the granules.

The selected plasticiser, by virtue of its high degree of compatibility with the aromatic active ingredient, facilitates the dispersion of the latter in the melt mass prior to the extrusion through the die and then finally provides the ability to optimise the aromatic load and dosing thereof in the aqueous solution.

Aromatic Active Ingredient

With the addition of the aromatic ingredient increasing the Tg of the granules obtained, it is indeed the plasticiser content that is to be optimised in order to ensure that a Tg greater than 40° C. is attained.

This dispersion of the aromatic ingredient in the melt mass is in addition facilitated by the emulsifier on which is mounted the aromatic ingredient, although this emulsifier has the primary objective of facilitating the dispersion of the aromatic ingredient without any occurrence of turbidity in the aqueous solution in which the granules will be incorporated.

The plasticiser used based on the content level which was determined on the basis of the Tg to be attained by the granules, is in fact quite likely to not be able by itself to allow for dispersion without any occurrence of turbidity of the aromatic ingredient in aqueous media.

The emulsifier incorporated on this occasion must be compatible with the aromatic ingredient and with the plasticiser.

Ideally, this emulsifier may have an HLB value comprised between 8 and 18, preferably greater than 10.

The polysorbates, lecithins, or extracts rich in saponins, which are emulsifiers that do not require prior hydration and are completely miscible with the majority of aromatic ingredients, are particularly suitable for achieving the objectives of the invention.

These emulsifiers are incorporated in admixture with the aromatic ingredient under pressure, just before the last mixing zone of the twin screw, in order to optimise the dispersion of the aromatic ingredient in the matrix, because they prevent the phenomena of phase separation and vaporisation, the emulsifier making possible better dispersion of the hydrophobic compounds such as terpenes in the hydrophilic matrix composed of carbohydrates and polar solvent.

Other emulsifiers may be used such as sucro esters, mono-glycerides, and di-glycerides of fatty acids alone or in a mixture.

The emulsifier will be used based on a content level in compliance with the relevant legislation in force, for example less than 5% by weight of the constituent ingredients of the granules, and greater than 0.1% by weight in order to perform their function of solubilising the aromatic ingredient. It allows for the formation of a fine emulsion of the active ingredient in the aqueous solution in which the granules are introduced and thereby prevents the formation of turbidity.

It is to be noted that when the granules are intended to be incorporated into preparations for solid foods, such as biscuits, in which by definition the notion of turbidity or cloudiness in the solution would not arise, it would not be absolutely essential for the aromatic ingredient to be combined with the emulsifier prior to its injection into the melt mass. In this more particular application, the use of glucose as a source of monosaccharide would also be avoided, the latter tending to make the matrix more sticky and thus resulting in difficulties during the course of the granulation in the extruder outlet. The aromatic ingredients contained in these granules intended for use in the biscuit and cookie manufacturing industries, will become distributed in a homogeneous manner in the cookie dough on account of the mechanical action of the kneading process.

The aromatic ingredients that may possibly be encapsulated according to the method of the invention, are those included in the categories defined in the EC Regulation 1334/2008 of the European Parliament and of the European Council dated 16 Dec. 2008, or a mixture included in several of these categories:
flavouring substances
natural flavouring substances
flavouring preparations
flavourings obtained by thermal processing
smoke flavourings
precursors of flavourings
other flavourings
food ingredients having flavouring properties

Quite obviously, other active ingredients in compliance with other legislation could possibly be subjected to encapsulation processes by the method according to the invention.

The method provides for the aromatic ingredient to be used based on a content level of between 0.1% and 10% by weight of the constituent ingredients of the granules. The top threshold margin may however be exceeded since a high content of aromatic ingredient does not decrease the Tg of the granules obtained. However, it will be necessary to appropriately adapt the plasticiser content and emulsifier content in order to disperse this flavouring substance in the melt mass.

Similarly, this method may be used for the encapsulation of pharmaceutical active ingredients, perfumes, cosmetic products and hygiene products, these being applications for which the short lasting exposure of the active ingredient to the extrusion temperature and the low value of this extrusion temperature are all the more significant given the fact that that the active ingredients are heat sensitive.

It is also possible to apply the invention to the production of granules comprising of food supplements.

Examples of embodiments of the aromatic granules according to the invention include:

1) Peach flavouring granules (% by weight):

Powder Matrix:

Saccharose: 41.2

Maltodextrin DE 9: 50.3

Plasticiser:

MPG E1520: 5

Peach flavouring aromatic base: 2.92

Emulsifier:

Polysorbate E432: 0.58

Extrusion temperature T: 86° C. (max)

Extrusion pressure P: <15 bars at stop

Tg of Granules: 47° C.

2) Orange flavouring granules (% by weight):

Powder Matrix:

Saccharose: 42.2

Maltodextrin DE 9: 51.6

Plasticiser:

MPG E1520 2.1

Orange flavouring aromatic base: 2.1

Emulsifier:

Polysorbate E432: 2

Extrusion temperature T: 85° C. (max)

Extrusion pressure P: <15 bars at stop

Tg of Granules: 61° C.

In the two above examples, the size of the oily particles after dispersion in the aqueous medium is approximately comprised between 10 nm and 500 nm.

1. A method for producing granules that contain at least one active ingredient and are stable at ambient temperature, comprising, successively:
(1) preparing a matrix free of an active ingredient by mixing, without the addition of water, an encapsulation vehicle for the active ingredient and a non-aqueous plasticiser compatible with the vehicle and with the active ingredient, the encapsulation vehicle and the plasticiser being present in amounts that give the matrix a glass transition temperature that is higher than the ambient temperature;
(2) heating the matrix in an extruder to an extrusion temperature to produce an amorphous melt matrix;
(3) injecting the active ingredient into the melt matrix, to produce a melt mass with the active ingredient;
(4) extruding the melt mass including the active ingredient through a die and cutting the melt mass including the active ingredient into granules at a point of exit of the mass melt including the active ingredient from the die.

2. The method according to claim 1, wherein the plasticiser is selected from polyols and is a non-aqueous liquid.

3. The method according to claim 2, wherein the plasticiser is selected from the group consisting of monopropylene glycol or a derivative thereof, glycerol or a derivative thereof, and a mixture thereof.

4. The method according to claim 3, wherein when the active ingredient is rich in terpenes, selecting the plasticiser from the group consisting of glycerol diacetate, and/or glycerol triacetate, alone or in a mixture with monopropylene glycol or a derivative thereof, glycerol or a derivative thereof, and a mixture thereof.

5. The method according to claim 1, wherein the plasticiser is present in an amount that is less than a predetermined amount at which the glass transition temperature of the granules becomes greater than 40° C.

6. The method according to claim 1, wherein the plasticiser is present in an amount that is less than 6% by weight relative to the total weight of the constituents of the granules.

7. The method according to claim 1, wherein the plasticiser is present in an amount that is larger than 1% by weight relative to the total weight of the constituents of the granules.

8. The method according to claim 1, wherein the encapsulation vehicle comprises a monosaccharide or polysaccharides alone or in a mixture therewith, and maltodextrins.

9. The method according to claim 1, including mounting the active ingredient on an emulsifier facilitating dispersion of the active ingredient in the melt mass, and dispersion of the active ingredient as a fine emulsion in an aqueous solution in which the granules are incorporated.

10. The method according to claim 9, wherein the emulsifier has an HLB (Hydrophile-Lipophile Balance) value in a range from 8 to 18.

11. The method according to claim 10, wherein the emulsifier is selected from the group consisting of polysorbates, sucroesters, mono-glycerides and di-glycerides of fatty acids, emulsifiers rich in saponins and lecithins alone or in a mixture.

12. The method according to claim 1 comprising maintaining the temperature of the melt mass including the active ingredient at the outlet of the extruding, between 45° C. and 55° C.

13. Granules including an active ingredient, comprising:
maltodextrin and polysaccharides in a ratio of between 80/20 and 20/80;
between 1% and 6% of MPG; and
between 0.1% and 10% of an active ingredient.
